(19) United States
(12) Patent Application Publication
(10) Pub. No.: US 2021/0394330 A1
(43) Pub. Date: Dec. 23, 2021

(54) IMPROVED VIBROBLASTING METHOD AND RELATIVE MACHINE

(71) Applicant: Paolo Redaelli, Biassono (MB) (IT)

(72) Inventor: Paolo Redaelli, Biassono (MB) (IT)

(21) Appl. No.: 17/292,746

(22) PCT Filed: Feb. 28, 2020
(86) PCT No.: PCT/EP2020/055245

§ 371 Date: May 11, 2021

(30) Foreign Application Priority Data
May 21, 2019 (IT) 102019000007052

(51) Int. Cl. B24B 31/073; B24B 31/16; B24C 1/10; B24C 5/00; B24C 9/00; B24C 11/00

(52) U.S. Cl. CPC B24B 31/073; B24B 31/16; B24C 1/10; B33Y 80/00; B24C 9/003; B24C 11/00; B24C 5/005

(57) ABSTRACT

A method for vibroblasting surfaces using a vibroblasting machine, said vibroblasting machine being equipped with at least one toroidal shaped process vat (50) which is set in a rotary motion and is suitable for containing workpieces whose surfaces are subjected to a vibroblasting processing, said method including a phase of inputting fine particles belonging to a sandblasting media into said process vat (50) to proceed with a sandblasting action of the surfaces of the workpieces being processed, and a phase of evacuation of said fine particles, characterized in that the phase of inputting fine particles belonging to the sandblasting media into said process vat (50) occurs from top to bottom or tangentially to the circumference of said process vat (50) and to the surface of the vibrating mass (75) of the workpieces and of the media.

### FIELD OF INVENTION

This invention refers to a method or process for vibratory finishing that has been improved and combined with a sandblasting method called vibroblasting or vibrosandblasting.

The invention also concerns a machine suitably configured to implement the combined method according to the invention, as well as a relative type of vibratory media and a relative type of sand blasting or shot peening media.

### PRIOR ART

From the Italian patent IT 1400984 it is known a process of mass finishing of surfaces which includes a feeding phase of fine particles, or sand blasting or shot peening media, inside a vibrofinishing or tumbling machine having at least one toroidal volume process vat containing parts in the finishing stage.

The method further includes a rotary motion generation phase of the said vibratory or tumbling machine, where this rotary motion phase is such as to create a fluid flow of said fine particles or grit or blasting media, at least between the workpieces and an evacuation phase of said fine particles.

In particular, the evacuation phase shall be carried out in such a way as to balance the amount of fine particles fed with the amount of particles evacuated.

The machine described in this patent provides a siphon-filter aspirator equipped with a mixing unit and an air gun to introduce the fine particles inside a vibro-burating machine from which a suction manifold starts to return to the above mentioned aspirator-filter.

The machine is equipped with a control panel to manage the evacuation phase in order to balance the amount of fine particles fed with the amount of evacuated particles.

Although this prior machine is perfectly capable of performing vibrofinishing operations on various types of metal and plastic components having all kinds of origins (laser cutting, water cutting, casting, die-casting, micro-casting, sintered, extruded, punched, truncated, etc.), there are still problems associated with improving finishing processes in the case of particular applications in the Additive Manufacturing sector, also known as 3D Printing.

Parts made with such innovative techniques can be made using additive processes involving polymeric or metallic powders, often of high economic value.

Some parts of this type can be made for the medical field using newly developed techno polymers, such as polyetheretherketone (PEEK), for example for maxillofacial or other components.

A purpose of this invention is therefore to improve the existing machine and processes in order to be able to optimally treat also components derived from Additive Manufacturing processes.

A further aim of this invention is to achieve the above results in a practical and economical way.

### BRIEF SUMMARY OF THE INVENTION

The technical problems highlighted above are solved by a method for vibroblasting surfaces using a vibroblasting machine, said vibroblasting machine being equipped with at least one toroidal shaped process vat which is set in a rotary motion and is suitable for containing workpieces whose surfaces are subjected to a vibroblasting processing, said method including a phase of inputting fine particles belonging to a sandblasting media into said process vat to proceed with a sandblasting action of the surfaces of the workpieces being processed, and a phase of evacuation of said fine particles, characterized in that the phase of inputting fine particles belonging to the sandblasting media into said process vat occurs from top to bottom or tangentially to the circumference of said process vat and to the surface of the vibrating mass of the workpieces and of the media.

An advantage of this realization is that it extends the scope of the known technique to the treatment of parts derived from Additive Manufacturing or 3D Printing processes.

These processes include the following processes:

SLA—Stereolithography, which is an exceptional technique for conceptual models, rapid prototypes, master models, snap groups and form and suitability tests.

### DMLS—Direct Metal Laser Sintering

### EBM—Electron Beam Melting

### FDM—Fused Deposition Modelling

PolyJet—PolyJet 3D Printing Technology for Rapid Prototyping is an advanced additive manufacturing method patented by Stratasys.
SLM—Selective Laser Melting (SLM), also known as Direct Metal Laser Sintering (DMLS) or Laser Powder Bed Fusion (LPBF), is a rapid prototyping, 3D printing, or Additive Manufacturing (AM) technique using a high power density laser to melt and fuse metal powders together.
SLS—Selective Laser Sintering, is a perfect technique for functional testing, rapid prototyping and for high heat and chemical resistant applications.

According to a realization of the invention, the sandblasting action is applied to a mass composed only of workpieces placed in a condition to tumble in a three-dimensional space or to workpieces and vibrofinishing media in an indicative proportion equal to ⅔ in volume of workpieces and ⅓ in volume of vibrofinishing media and in any case not exceeding a ratio of ⅓ in volume of workpieces and ⅔ in volume of vibrofinishing media.

This solution allows the real achievement of the action of a double process in a single cycle, that is, on the one hand the investment of the surfaces with a sandblasting jet suitably directed, from the top vertically downwards or from tangential zone to the mass with adjustable angle between almost horizontal and 45°, and on the other hand by the dragging between the surfaces of the workpieces, or of the workpieces and vibratory media, during the portion of the cycle not involved by blasting jet, such as to optimize the finish for the dragging or rubbing of the blasting grit (using for example glass beads, corundum, garnet, metal grit, plastic grit, grit of walnut shells or of other vegetable origin or other abrasive or non-abrasive grit).

The vibratory finishing media used can also be produced according to the teachings of the European patent EP 2 127 809.

Briefly, this patent describes abrasive preformed elements for mass finishing of surfaces, tumbling and vibratory finishing and the like, where each of these elements includes at least one abrasive component or a mixture of abrasives, dispersed in a thermoplastic binder and a thermosetting binder, and an additional component to provide the preformed element with the desired density.

Examples of components that can be used to achieve the desired density can be:
Barite—4.5 Kg/dm³
Silicon carbide—3.2 Kg/dm³
Feldspar—2.6 kg/dm³
Hollow glass spheres—<1 Kg/dm³
Zircon—4.7 Kg/dm³.

These components can be available in various geometric shapes such as cylinders, cubes, spheres, square or triangular pyramids, cones, prisms, tetrahedrons and more.

These vibrofinishing media may be indicated below, for brevity, with the abbreviation QF.

According to a further realization of the invention, for the blasting action it is used the same polymeric or metallic powder of which the workpieces are composed.

The sand blasting or shot peening media used, normally abrasive or non-abrasive grits, glass or plastic or zirconium or ceramic microspheres, plastic grits, metal grits, may also be: dry ice pellets, pure or additive ice grits, walnut shell grits or other vegetable grits (whether or not impregnated with abrasive or impregnating substances or creams), polymeric or metal powders, granules or grits of any shape or hardness, alone or with inert and/or absorbent substances.

An advantage of this invention is that it defines a new possibility of finishing or combined process between vibratory finishing and sandblasting for all those components made by Additive Manufacturing where there is no risk of polluting the surface treated with abrasives and other types.

For example, a maxillofacial PEEK component cannot risk being treated with corundum that could be included in the surface.

In order to avoid this risk it is planned to use the same polymeric powder as PEEK to sandblast the PEEK components thus minimizing the risk of contamination.

According to a further realization of the invention, finishing media manufactured with Additive Manufacturing processes and having the most varied shapes and sizes and made from a software library of three-dimensional finishing media that can be printed with the same type of material as the workpieces are used.

The invention also foresees a machine for the actuation of the method described, wherein said machine provides for a suction and filter unit and a compressed air sandblasting nozzle to introduce the fine particles belonging to the sandblasting media into a process vat from which depart an intake manifold that returns to said suction and filter unit, where the said machine includes a sandblasting nozzle placed above the process vat or tangentially with respect to said process vat and to the surface of the vibrating mass of the workpieces and of the media.

In particular, in the configuration in which the blasting nozzle is placed tangentially, the shot is tangential to the surface of the mass of the pieces and the vibrating media, thus involving a greater area than the vertical shot. The sand blasting media, before being discharged from the evacuation filter, perform almost 360 degrees in the vibrating vat, involving the pieces both by firing and by vibration in a sort of fluid finishing bed.

According to a realization of the invention, in the machine there is a powder suction point, different from the evacuation filter placed on the bottom of the vat, which is part of the process and its “smart recovery” powder recovery device (or aspirator), which allows in the very first phase of the cycle to remove most of the powder remaining on the surface of the components.

After this phase, the previously described phases of sand blasting and suction of the blasting grit are started.

However, some plants supplied in PCCP (Preventive Contamination Clinic Process) version, allow to use the additive powder also for vibro-sandblasting.

The term PCCP refers to the stages of recovery of the majority of powder or powder removal, sandblasting with the use of the same type of additive powder or the same material (or family of compatible materials) to avoid pollution with foreign substances (or incompatible or such to cause inclusions) that would be harmful in the case of components for clinical, medical and/or orthopedical use.

The action described above, in the case of components made by Additive Manufacturing with powdery residues, can therefore be performed by a second and specific filtration and extraction area with the aim of removing the precious additive powder (polymeric or metallic) before sandblasting.

This function can be facilitated by the vibratory action combined with the micro hammering of the parts on each other, or the parts with the QF finishing media, together with the above mentioned suction action.

Finally, the machine is equipped with a control panel with man-machine interface (HMI) touch screen and software suitable for the management of method variables such as times and vibratory frequencies of the various cycle phases and many other programmable parameters.

This is useful, for example, because a typical phase of the vibro-sandblasting cycles is the final suction. Once the sandblasting phase is completed, the jet is stopped while suction continues for a programmable time in order to remove the residual abrasives.

This fact is also useful, to give a further example because, as already mentioned above, there is an interesting phase of the vibro-sandblasting cycles of components in Additive manufacturing, which consists of the so-called “smart recovery”, namely the preliminary phase dedicated to recover as much powder as possible left in the loops and undercuts of the treated components. Once the vibro-powder recovery or “smart recovery” phase is completed, with a special suction point, the software stops this phase and activates the components that control over the vibro-sandblasting phase.

Further features of the invention can be inferred from the dependent claims.

### BRIEF DESCRIPTION OF THE FIGURES

Further features and advantages of the invention will be evident from reading the following description provided by way of non-limitative example, with the help of the figures illustrated in the attached tables, in which:

FIG. 1 shows an axonometric view of a vibratory sandblasting machine according to a realization of the invention;

FIG. 2 shows an axonometric view of a vibratory sandblasting machine according to another realization of the invention;

FIG. 3 shows an axonometric view of a vibratory sandblasting machine according to a further realization of the invention; and

FIGS. 4 and 5 show axonometric views, partially in section, of a process vat that can be used with the machine in FIG. 2.

FIG. 6 shows various possible forms of vibrofinishing media, which can be produced in Additive Manufacturing or available in QF version;

FIG. 7 shows various possible forms of blasting or shot peening media, or even grits or microspheres, which can be made with the same grits or powders for Additive Manufacturing or available in various materials, shapes and hardnesses; and

FIGS. 8-10 show further views of a process vat that can be used with the machine in FIG. 2.

### DETAILED DESCRIPTION OF SOME FORMS OF REALIZATION OF THE PRESENT INVENTION

As indicated above, it is necessary to distinguish, in the context of the present invention, between vibrofinishing media and sand blasting media.

The vibratory finishing media vibrate or rotate in the bowl and act in contact with the workpiece surfaces.

The blasting media are first fired, through appropriate nozzles and in the manner described below and then dragged.

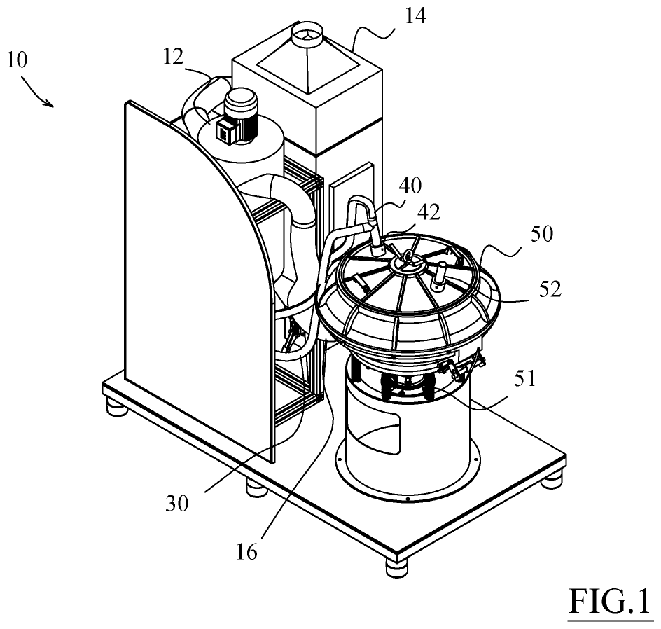

With initial reference to FIG. 1, it shows a side view of a vibratory sandblasting machine according to a realization of the invention and globally indicated with numerical reference 10.

The machine 10 for vibrosandblasting that provides for a compressed air gun 42 to shoot the sand powder, or a granular or solid compound inside a vibrosandblasting process vat 50 and against the workpieces, with the help of compressed air. In particular, there are two tubes, namely a tube 30 for powder supply and a tube 40 for compressed air supply and with this system, according to what is already known in the field, a Venturi effect is created on the powders that allows them to be fed into the process vat 50, thus creating a sandblasting action.

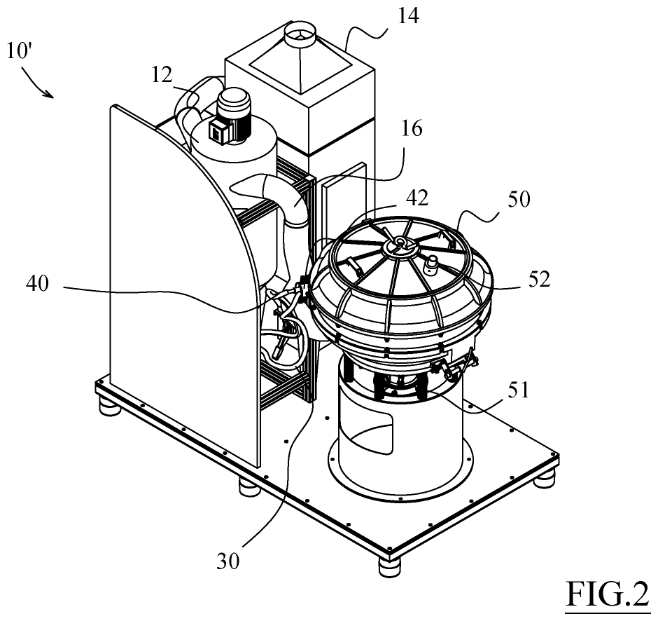

The compressed air gun 42 is connected to a blasting nozzle 42′ which can be placed above the process vat 50 (as in FIG. 1) or tangentially to the above process vat 50, as in the machine 10′ shown in FIG. 2.

Process vat 50 is mounted on springs 51 and is vibrated by a motor (not represented for simplicity) and an air inlet snorkel 52.

Machine 10 also has an intake manifold 16 that is connected to a filter 55 that lets the blasting media pass out of the process vat 50 and the air entering from the snorkel 52 to intake manifold 16.

The suctioned material is treated by a cyclone 12 in which the lightest powders rise tangentially upwards and separate from the sand blasting media and are conveyed to a filter cabinet 14, all forming a suction and filter unit.

Machine 10 is also equipped with a control panel with human-machine interface (HMI) touch screen and software suitable for the management of method variables such as times and vibratory frequencies of the various cycle phases and many other programmable parameters.

FIG. 2 shows an axonometric view of a 10′ machine for vibrosandblasting according to another realization of the invention, where said 10′ machine differs from the previous machine due to the fact that the compressed air gun 42 is connected to a blasting nozzle 42′ placed tangentially to the above mentioned process vat 50.

The blasting nozzle 42′ is also placed tangentially to the surface of the mass 75 of the workpieces and of the vibrating media.

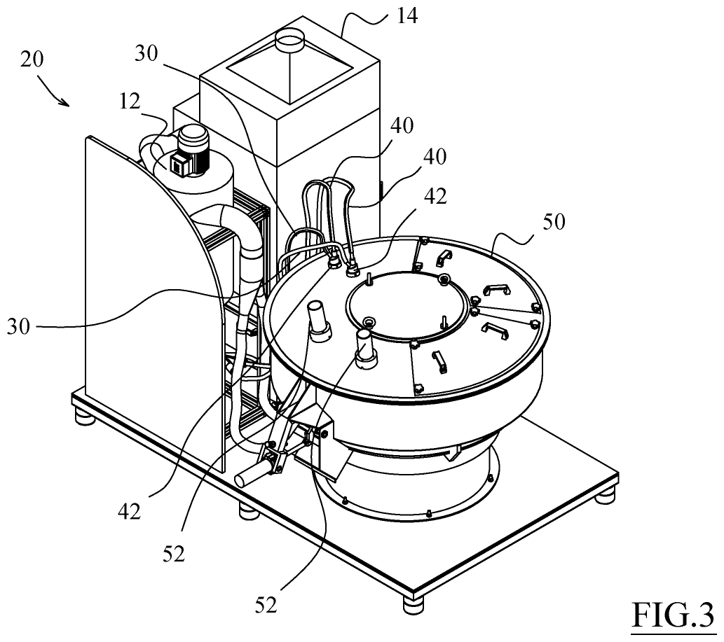

FIG. 3 shows an axonometric view of a vibratory sandblasting machine 20 according to a further realization of the invention, wherein said machine 20 is larger than the previous machines and has two compressed air guns 42, both placed higher than the process vat 50 and both fed by respective powder supply pipes 30 and compressed air supply pipes 40.

Process vat 50 of machine 20 also includes two snorkels 52 and double filter for discharge and recovery of blasting powder or grit on the bottom of the vat.

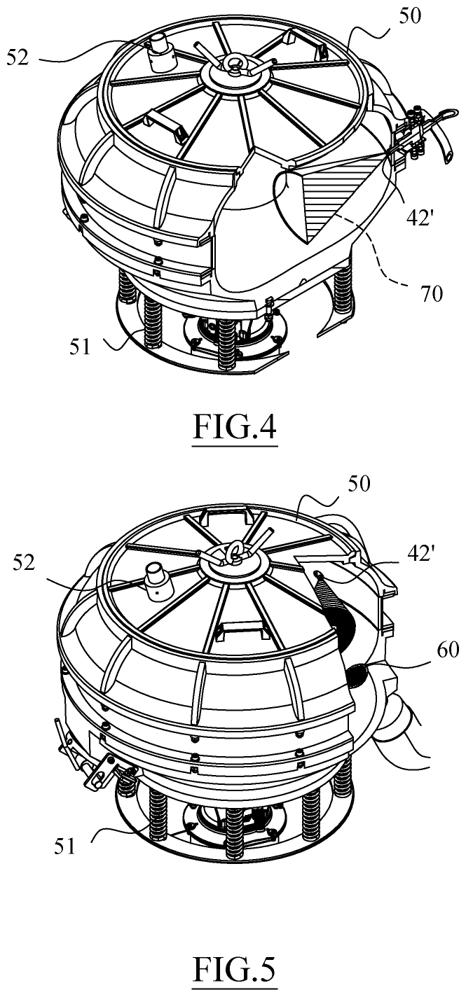

FIGS. 4 and 5 show axonometric views, partially in section, of a process vat 50 that can be used with the machine in FIG. 2.

In these figures it can also be seen a nozzle 42′ placed tangentially and creating a spray cone indicated with 70, as well as a filter 60′ that connects to the suction line 16.

In addition, each of the machines described can provide a powder suction point usually consisting of an additional snorkel with adjustable height towards the inside of the vat, or a suction point inserted in the circular ring of the machine in version 20), different from the evacuation filter 60 placed on the bottom of the vat, which allows in the very first phase of the cycle to recover, where required, through the “smart recovery” phase, most of the powder remaining on the surface of the components.

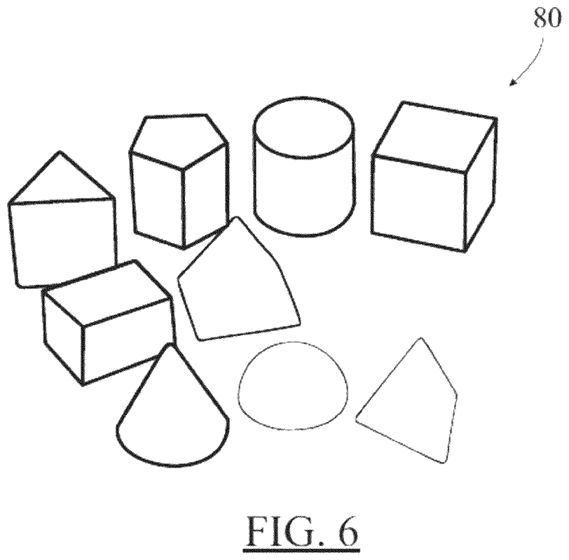

FIG. 6 shows various possible forms of vibrofinishing media, which can be made by Additive Manufacturing or available in QF version, globally indicated with the numerical reference 80.

These media can be available in various geometric shapes such as cylinders, cubes, semi-spheres, square or triangular pyramids, cones, prisms, tetrahedra and others.

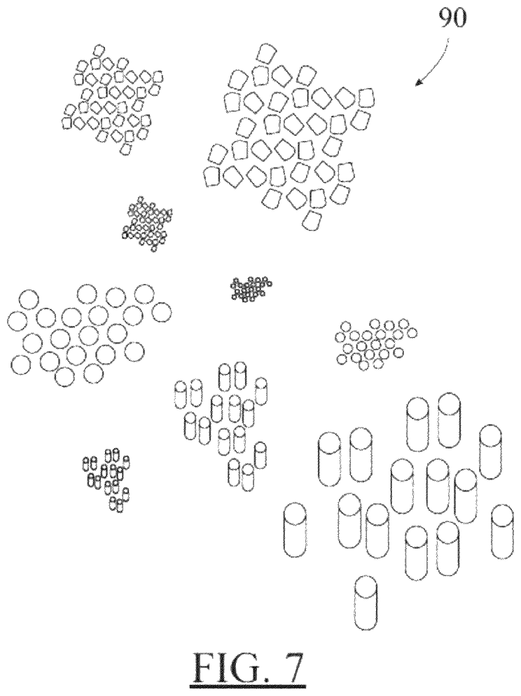

FIG. 7 shows various possible shapes of sand blasting or shot peening media, or even grits or microspheres, which can be made with the same grits or powders for Additive Manufacturing or available in various materials, geometrical shapes and hardnesses.

These sand blasting media are globally referred to as 90.

In the operation of the described machines, fine particles belonging to sand blasting media are fed into process vat 50 in order to proceed to a sand blasting action on the surfaces of the workpieces, and an evacuation phase of the above mentioned fine particles, where the feeding phase of fine particles into process vat 50 takes place from top to bottom (FIGS. 1 and 3) or tangentially (FIGS. 2,4 and 5) with respect to the circumference of the above mentioned process vat 50.

In particular, the feeding of fine particles into the process vat can take place tangentially to the circumference of the process vat and the surface of the mass 75 of the workpieces and media in vibration.

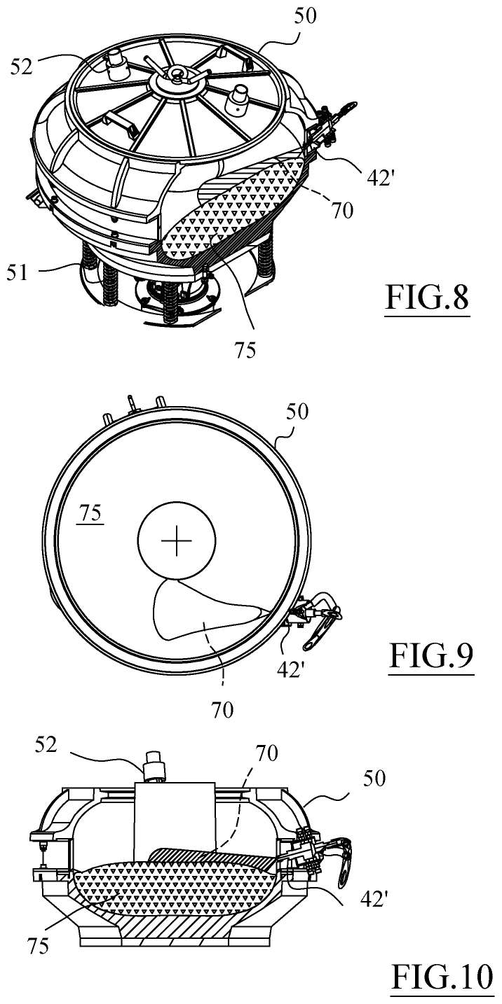

FIGS. 8 and 9 show further views of a process vat that can be used with the machine in FIG. 2.

In particular FIG. 8 shows the feeding action of fine particles into the process vat in perspective view and FIG. 9 in top view, while FIG. 10 shows a section along a vertical plane of the process vat.

FIGS. 8-10 also show in a clear way the mass 75 of the workpieces and the vibrating media in such a way that, according to one aspect of the invention, the spraying cone 70 of the blasting media generated by the nozzle 42′ acts tangentially to the surface of the mass 75 of the workpieces and the vibrating media.

The spray cone 70 of the sand blasting media generated by nozzle 42′ also acts from top to bottom on the surface of the mass 75 of the workpieces and the vibrating media.

In particular, the sand blasting action can be carried out by feeding fine particles belonging to the sand blasting media and is applied to a mass composed only of pieces placed in a condition to tumble three-dimensionally or to workpieces and vibrofinishing media in an approximate proportion equal to ⅔ in volume of workpieces and ⅓ of vibrofinishing media and in any case not exceeding a ratio of ⅓ in volume of workpieces and ⅔ of finishing media.

The action on the workpieces and their surfaces is therefore a combination of the actions of the sand blasting media, introduced through nozzle 42, and the vibratory finishing media present in the process vat 50.

This does not exclude that, for some processes, the vibratory finishing media are not present and their function is replaced by direct contact of the workpieces against each other, all under the sandblasting action of the sandblasting media.

Inside the process vat 50 a depression is created that determines the exit of the abrasive or powder or blasting media after a certain distance travelled inside the process vat 50 between the pieces in order to reuse them for further use for the blasting action or to remove all the remaining abrasive or powder without continuing with the blasting action.

In the case of medical pieces or pieces made by Additive Manufacturing, the same polymeric or metallic powder is used for the blasting action as the pieces being processed.

With regard to vibratory finishing media or to sand blasting media, media can be used that are also manufactured using Additive Manufacturing processes and have the most varied shapes and sizes and are made from a software library of three-dimensional media that can be printed with the same type of material as the workpieces.

The method or process described in the present invention, as a synergistic component of sand blasting or shot peening, is also applicable to tumbling processes with rotary tumbler, even with centrifugal force tumbling with rotary disc machines: disc finishing), wave finishing, drag finishing and, finally, with rectangular, linear continuous cycle and circular continuous cycle vibrofinishing machines (both spiral and long radius type).

The method of the invention which benefits from the synergistic component of sand blasting or shot peening, dry and vacuum, is also applicable to synergistic processes of sand blasting or shot peening, dry and pressure blasting, or wet blasting, or with turbine blasting machines.

The invention method, in the part referring to powder recovery or “smart recovery”, is applicable to the concept of PCCP (Preventive Contamination Clinic Process), to the combination of vibratory finishing and sand blasting or shot peening or shot blasting, although many aspects are aimed at the Additive manufacturing or 3D printing sector, similar operations may be extended to other sectors where such methods or processes are equally functional.

Obviously, the invention as described may be modified or improved for contingent or particular reasons, without departing from the scope of the invention as claimed below.

1. Method for vibroblasting surfaces using a vibroblasting machine, said vibroblasting machine being equipped with at least one toroidal shaped process vat (50) which is set in a rotary motion and is suitable for containing workpieces whose surfaces are subjected to a vibroblasting processing, said method comprising
a phase of inputting fine particles belonging to a sandblasting media into said process vat (50) to proceed with a sandblasting action of the surfaces of the workpieces being processed, and
a phase of evacuation of said fine particles, wherein the phase of inputting fine particles belonging to the sandblasting media into said process vat (50) occurs from top to bottom or tangentially to the circumference of said process vat (50) and to the surface of the vibrating mass (75) of the workpieces and of the media.

2. Method for vibroblasting as in claim 1, wherein the sandblasting action is applied to a mass composed only of workpieces placed in a condition to tumble in a three-dimensional space or to workpieces and vibrofinishing media in an indicative proportion equal to ⅔ in volume of workpieces and ⅓ in volume of vibrofinishing media, said mass not exceeding a ratio of ⅓ in volume of workpieces and ⅔ in volume of vibrofinishing media.

3. Method for vibroblasting as in claim 1, wherein a depression is created inside the process vat (50) that determines the exit of abrasives or powder or sandblasting media after a path travelled inside the process vat (50) between the workpieces in order to recover and reuse the abrasives or powder or sandblasting media for further phases for the action of sandblasting or to remove all the residual of abrasive or of powder or of sandblasting media without continuing with the action of sandblasting.

4. Method for vibroblasting as in claim 3, where powder recovery is applicable for PCCP (Preventive Contamination Clinic Process) processing, or to the combination of vibrofinishing and sandblasting or shot peening or blasting.

5. Method for vibroblasting as in claim 1, wherein the sandblasting media used in the sandblasting action are made of polymeric or metallic powder used to make the workpieces.

6. Method for vibroblasting as in claim 1, wherein said sandblasting media and/or said vibrofinishing media are manufactured using Additive Manufacturing processes, said sandblasting media and/or said vibrofinishing media being manufactured from a software library of three-dimensional media printed with material used for the workpieces.

7. Method for vibroblasting as in claim 1, said method being applicable to tumbling processes selected from the group consisting of tumbling processes with a rotary tumbler, with centrifugal force tumbling with rotating disc finishing machines, with flow finishing, with wave finishing and with rectangular, linear continuous cycle, circular continuous cycle vibratory finishing machines, both of spiral and of “long radius” type.

8. Method for vibroblasting as in claim 1, wherein applicable to synergistic processes of air blasting or shot peening, dry and pressure processes, or wet, or with turbine blasting machines.

9. Machine (10) for the actuation of the method as in claim 1, comprising
a suction and filter unit and
a compressed air sandblasting nozzle (42) to introduce the fine particles belonging to the sandblasting media into a process vat (50) from which departs an intake manifold (16) that returns to said suction and filter unit, wherein said machine (10) further comprises a sandblasting nozzle (42′) placed above the process vat (50) or tangentially with respect to said process vat (50) and to the surface of the vibrating mass (75) of the workpieces and of the media.

10. Machine (10) as in claim 9, wherein said machine (10) comprises an evacuation filter located on the bottom of the vat, and a powder suction point, wherein said powder suction point allows removing powder remaining on the surface of the vibrating mass of the workpieces and of the media.

11. Machine (10) as in claim 9, wherein said machine (10) further comprises a control panel with human-machine interface (HMI) touch screen and a software suitable for managing method variables comprising vibration times and frequencies of the cycle phases and programmable parameters.
